(19) United States
(12) Patent Application Publication
(10) Pub. No.: US 2025/0130371 A1
(43) Pub. Date: Apr. 24, 2025

(54) OPTICAL SWITCH AND OPTICAL SWITCH SYSTEM

(71) Applicant: NIPPON TELEGRAPH AND TELEPHONE CORPORATION, Tokyo (JP)

(72) Inventors: Tatsuya FUJIMOTO, Musashino-shi, Tokyo (JP); Tomohiro KAWANO, Musashino-shi, Tokyo (JP); Kazuhide NAKAE, Musashino-shi, Tokyo (JP); Hiroshi WATANABE, Musashino-shi, Tokyo (JP); Kazunori KATAYAMA, Musashino-shi, Tokyo (JP)

(73) Assignee: NIPPON TELEGRAPH AND TELEPHONE CORPORATION, Tokyo (JP)

(21) Appl. No.: 18/686,811

(22) PCT Filed: Sep. 1, 2021
(86) PCT No.: PCT/JP2021/032108

§ 371 Date: Feb. 26, 2024

(51) Int. Cl. G02B 6/35

(52) U.S. Cl. CPC G02B 6/3514

(57) ABSTRACT

An object of the present disclosure is to provide an optical switch and an optical switch system capable of achieving optical path switching with less power. In order to achieve the above object, an optical switch according to the present disclosure includes a plate-shaped cladding provided with a trench in a thickness direction, opposing lenses exposed to the trench, two optical waveguides coaxially arranged inside the cladding, respective one ends of the optical waveguides being exposed to a surface of the cladding and respective other ends of the optical waveguides opposing each other in the trench via the opposing lenses, a movable transparent body that transmits light of the opposing lenses when the transparent body is sandwiched by the opposing lenses in the trench, and a movable double-sided mirror that reflects light incident from the opposing lenses in a direction opposite to an incident direction when the double-sided mirror is sandwiched between the opposing lenses in the trench.

### TECHNICAL FIELD

The present disclosure relates to an optical switch and an optical switch system to be used mainly for switching paths among optical fiber lines using single-mode optical fibers in an optical fiber network.

### BACKGROUND ART

Various methods such as an optical fiber type mechanical optical switch that controls abutment between optical fibers or optical connectors by a robot arm, a motor, or the like have been proposed for an all-optical switch that performs path switching while maintaining light (see, for example, Non Patent Literature 1).

### CITATION LIST

### Patent Literature

Patent Literature 1: JP 3-11303 A Optical Circulator

Patent Literature 2: JP 11-119158 A Optical Circulator Array

Patent Literature 3: JP 11-125724 A Optical Integrated Circuit

### Non Patent Literature

Non Patent Literature 1: M. Ctepanovsky, “A Comparative Review of MEMS-Based Optical Cross-Connects for All-Optical Networks From the Past to the Present Day”, IEEE Communications Surveys & Tutorials, vol. 21, no. 3, pp. 2928-2946, 2019.

### SUMMARY OF INVENTION

### Technical Problem

However, the conventional technology disclosed in Non Patent Literature 1 has a problem in that it is difficult to further lower power consumption, reduce size, and lower costs. In general, an optical switch as described in Non Patent Literature has a problem that a large power of several hundred mW or more is required. In an environment where only an optical fiber is provided, such as an outdoor overhead optical connection point, it is difficult to secure sufficient power to drive these optical switches.

In order to solve the above problems, an object of the present disclosure is to provide an optical switch and an optical switch system capable of achieving optical path switching with less power.

### Solution to Problem

In order to achieve the above object, the optical switch and the optical switch system of the present disclosure achieve optical path switching by inserting a double-sided mirror on an optical path.

Specifically, an optical switch according to the present disclosure includes:
a plate-shaped cladding provided with a trench in a thickness direction;
opposing lenses exposed to the trench;
two optical waveguides coaxially arranged inside the cladding, respective one ends of the optical waveguides being exposed to a surface of the cladding and respective other ends of the optical waveguides opposing each other in the trench via the opposing lenses;
a movable transparent body that transmits light of the opposing lenses when the transparent body is sandwiched by the opposing lenses in the trench; and
a movable double-sided mirror that reflects light incident from the opposing lenses in a direction opposite to an incident direction when the double-sided mirror is sandwiched between the opposing lenses in the trench.

Specifically, an optical switch system according to the present disclosure includes:
the optical switch;
two three-port optical circulators that output an input of light from a first port to a second port and output an input of light from the second port to a third port;
two upper optical fibers connected to the first ports of the two three-port optical circulators;
two connecting optical fibers that connect the second ports of the two three-port optical circulators and the one ends of the two optical waveguides; and
two lower optical fibers connected to the third ports of the two three-port optical circulators, in which light incident from any one of the upper optical fibers is emitted to any one of the lower optical fibers to function as a two-input two-output optical switch.

Specifically, an optical switch system according to the present disclosure includes:
the optical switch;
two four-port optical circulators that output an input of light from a first port to a second port, output an input of light from the second port to a third port, output an input of light from the third port to a fourth port, and output an input of light from the fourth port to the first port;
two upper optical fibers connected to the first ports of the two four-port optical circulators;
two first connecting optical fibers that connect the second ports of the two four-port optical circulators and the one ends of the two optical waveguides;
two lower optical fibers connected to the third ports of the two four-port optical circulators; and
two second connecting optical fibers that connect the fourth ports of the two four-port optical circulators and the one ends of the two second optical waveguides, in which
light incident from any one of the upper optical fibers is emitted to any one of the lower optical fibers, and light incident from any one of the lower optical fibers is emitted to any one of the upper optical fibers to function as a two-input two-output optical switch.

### Advantageous Effects of Invention

According to the present disclosure, it is possible to provide an optical switch and an optical switch system capable of achieving optical path switching with less power.

### BRIEF DESCRIPTION OF DRAWINGS

FIG. 1 is a diagram describing a configuration of an optical switch system according to a first embodiment.

FIG. 2 is a diagram describing a configuration of the optical switch system according to the first embodiment.

FIG. 3 is a diagram describing a configuration of the optical switch system according to the first embodiment.

FIG. 4 is a diagram describing a configuration of an optical circulator according to the first embodiment.

FIG. 5 is a diagram describing a configuration of the optical switch system according to the first embodiment.

FIG. 6 is a diagram describing a configuration of the optical switch system according to the first embodiment.

FIG. 7 is a diagram describing a configuration of the optical switch system according to the first embodiment.

FIG. 8 is a diagram describing a configuration of the optical switch system according to the first embodiment.

FIG. 9 is a diagram describing optical paths in the optical switch system according to the first embodiment.

FIG. 10 is a diagram describing optical paths in the optical switch system according to the first embodiment.

FIG. 11 is a diagram describing a configuration of the optical switch system according to the first embodiment.

FIG. 12 is a diagram describing an optical path switching pattern according to the first embodiment.

FIG. 13 is a diagram describing a configuration of the optical switch system according to the first embodiment.

FIG. 14 is a diagram describing an optical path switching pattern according to the first embodiment.

FIG. 15 is a diagram describing a configuration of an optical switch system according to a second embodiment.

FIG. 16 is a diagram describing a configuration of a bidirectional optical circulator according to the second embodiment.

FIG. 17 is a diagram describing a configuration of the bidirectional optical circulator according to the second embodiment.

FIG. 18 is a diagram describing optical paths in the optical switch system according to the second embodiment.

FIG. 19 is a diagram describing optical paths in the optical switch system according to the second embodiment.

FIG. 20 is a diagram describing optical paths in the optical switch system according to the second embodiment.

FIG. 21 is a diagram describing optical paths in the optical switch system according to the second embodiment.

FIG. 22 is a diagram describing a configuration of an optical switch system according to a third embodiment.

FIG. 23 is a diagram describing a configuration of the optical switch system according to the third embodiment.

FIG. 24 is a diagram describing a configuration of an optical switch system according to a fourth embodiment.

### DESCRIPTION OF EMBODIMENTS

Hereinafter, embodiments of the present disclosure will be described in detail with reference to the drawings. Note that the present disclosure is not limited to the embodiments described below. These embodiments are merely examples, and the present disclosure can be carried out in forms with various modifications and improvements based on the knowledge of those skilled in the art. Note that components having the same reference signs in the present description and the drawings denote the same components.

### First Embodiment

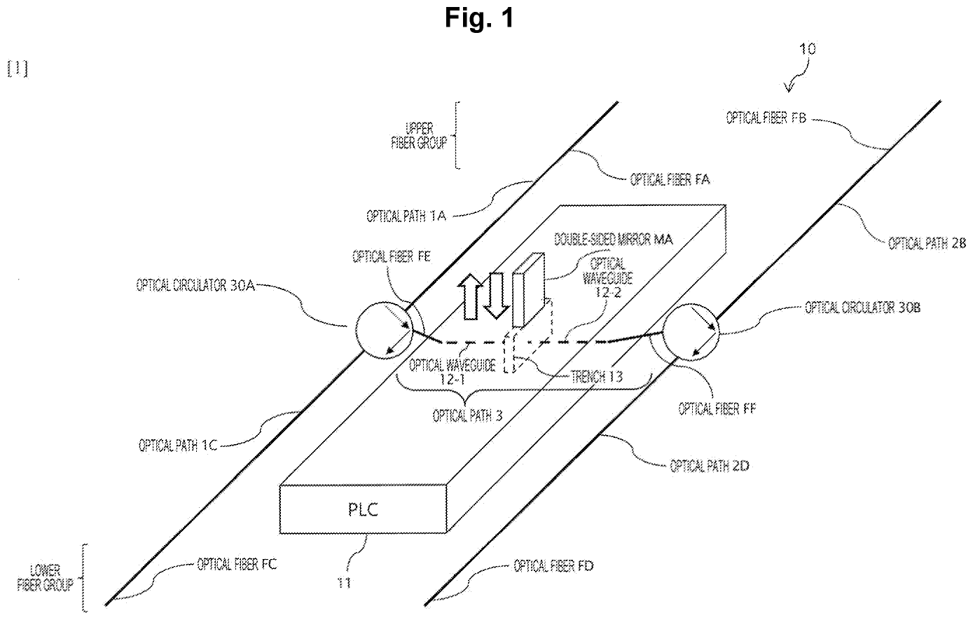

FIG. 1 is a configuration diagram of a first embodiment. The optical switch 10 connects an upper fiber group of an optical fiber FA and an optical fiber FB and a lower fiber group of an optical fiber FC and an optical fiber FD by switching optical paths.

An optical circulator 30A is a three-port optical circulator to be described later in the present embodiment. The optical fiber FA and the optical fiber FC are connected by the optical circulator 30A, and the optical fiber FB and the optical fiber FD are connected by an optical circulator 30B. The optical circulator 30A is connected to a planar lightwave circuit (PLC) 11 via an optical fiber FE, and the optical circulator B is connected to the PLC 11 via an optical fiber FF.

The PLC 11 has waveguides 12 in a plate-like cladding, and a trench 13 for inserting a double-sided mirror is disposed on the waveguides 12 so as to cross the waveguides 12. The trench 13 is formed in a thickness direction of the cladding. In the present embodiment, the waveguides 12 divided by the trench 13 are denoted by reference signs 12-1 and 12-2, and when they are not distinguished, they are denoted as the waveguides 12. In addition, in the following embodiment, an example in which the waveguides 12 are formed linearly will be described, but the waveguides 12 may have any shape according to the design of the PLC. In addition, lengths of the optical waveguides 12-1 and 12-2 may be the same, but the functions and effects of the present disclosure can be obtained even if the lengths are different.

In the present embodiment, a double-sided mirror MA that can be inserted into the trench 13 is disposed. The double-sided mirror MA is movable in the thickness direction of the cladding. The double-sided mirror MA reflects light incident from the optical waveguides 12-1 and 12-2 in a direction opposite to the incident direction when the double-sided mirror MA is sandwiched between the optical waveguides 12-1 and 12-2 in the trench 13.

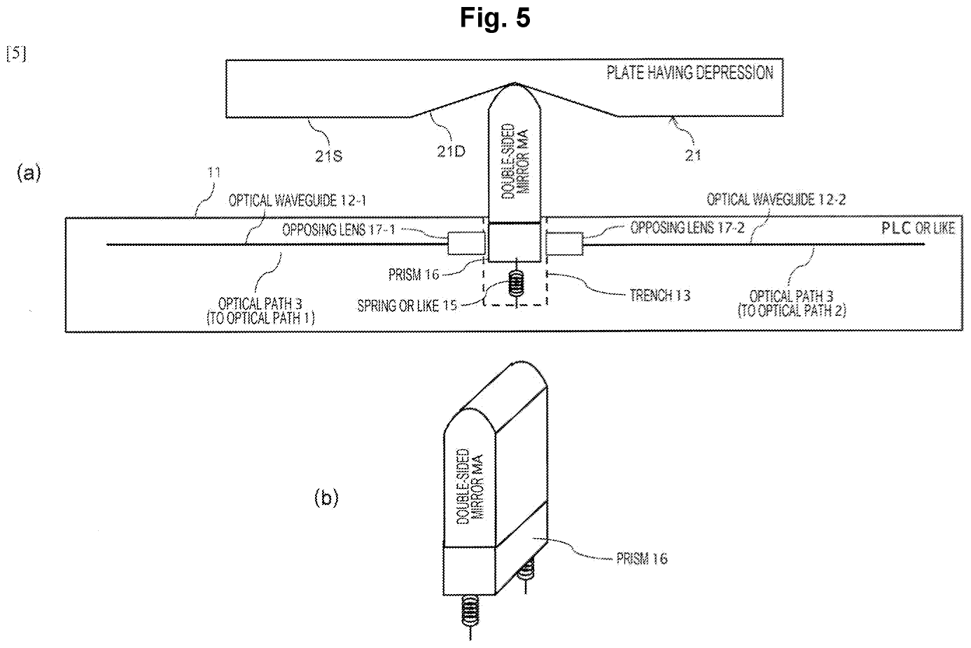

In the present embodiment, a prism (reference sign 16 in FIG. 5) that can be inserted into the trench 13 is arranged. The prism 16 is movable in the thickness direction of the cladding. The prism 16 transmits light incident from the optical waveguides 12-1 and 12-2 when being sandwiched between the optical waveguides 12-1 and 12-2 in the trench 13. Here, the prism 16 is any transparent medium that transmits the propagation light of the optical waveguides 12-1 and 12-2, and may be air.

In the present embodiment, opposing lenses (reference signs 14-4 and 14-5 illustrated in FIG. 5) exposed to the trench 13 are provided. In a case where the opposing lens 14-4 is provided, light from the optical waveguide 12-1 to the trench 13 is emitted to the trench 13 via the opposing lens 14-4. In a case where the opposing lens 14-5 is provided, light from the optical waveguide 12-2 to the trench 13 is emitted to the trench 13 via the opposing lens 14-5.

The optical waveguide 12-1 having one end connected to the optical fiber FE on the surface of the PLC 11 and the optical waveguide 12-2 having one end connected to the optical fiber FF of the PLC 11 are coaxially disposed inside the PLC 11. The trench 13 into which the double-sided mirror MA is inserted is provided between the other end of the optical waveguide 12-1 and the other end of the optical waveguide 12-2. In order to optically connect the other end of the optical waveguide 12-1 and the other end of the optical waveguide 12-2, a transparent body such as a prism (reference sign 16 to be described later) that transmits light may be disposed inside the trench 13 and on the axes of the optical waveguide 12-1 and the optical waveguide 12-2. The double-sided mirror MA is disposed at a position where the double-sided mirror MA can be inserted into the trench 13, for example, on the trench 13 or in the trench 13, and is inserted into the trench 13 or pulled out of the trench 13, thereby changing an optical connection state (interruption or connection) between the optical waveguide 12-1 and the optical waveguide 12-2.

Here, in FIG. 1, the optical fiber FA is referred to as an optical path 1A, the optical fiber FC is referred to as an optical path 1C, and the optical path 1A and the optical path 1C are collectively referred to as an optical path 1. In addition, the optical fiber FB is referred to as an optical path 2B, the optical fiber FD is referred to as an optical path 2D, and the optical path 2B and the optical path 2D are collectively referred to as an optical path 2. Further, the optical fiber FE, the optical waveguide 12-1, the optical waveguide 12-2, and the optical fiber FF are collectively referred to as an optical path 3.

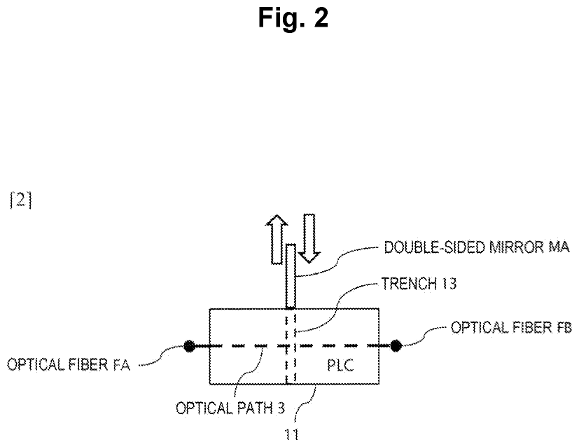

In order to describe an example of the positional relationship between the trench 13 and the double-sided mirror MA, FIG. 2 is a side view of the PLC 11 viewed from the long axis direction of the optical fiber FA and the optical fiber FB. The optical path 3 linearly penetrates the PLC 11, and the trench 13 is provided perpendicular to the optical path 3. The double-sided mirror MA is inserted into the trench 13 to block the optical path 3. The double-sided mirror MA inserted into the trench 13 is pulled out in a direction perpendicular to the optical path 3 to enable optical connection of the optical path 3. A method for driving double-sided mirror MA will be described later.

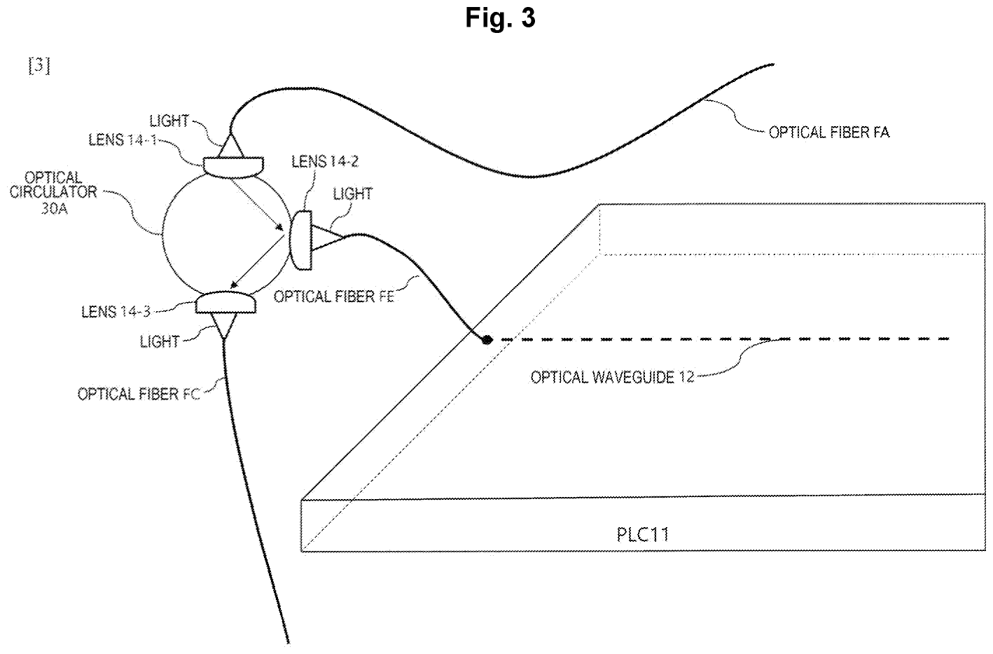

An example of a configuration between the optical circulator 30A and the optical waveguide 12 including bulk components will be described with reference to FIG. 3. The optical fiber FE connected to the optical waveguide 12 and a lens 14-2 of the optical circulator 30A are optically connected, so that input and output of light between the optical circulator 30A and the optical waveguide 12 are achieved. On the other hand, a waveguide type optical circulator of an existing technology can also be used (see, for example, Patent Literatures 1 to 3).

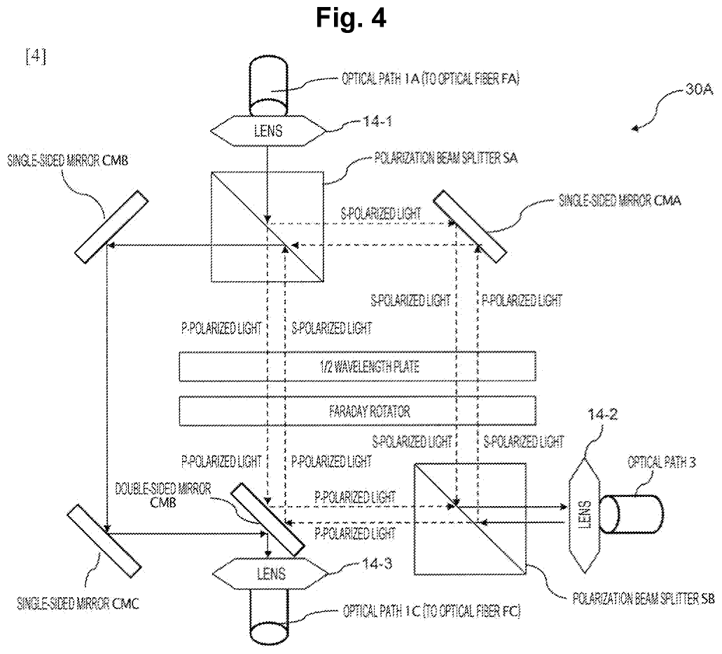

An operation principle of the optical circulator 30A in FIG. 1 will be described with reference to FIG. 4. FIG. 4 illustrates an optical circulator constituted by a bulk component as an example of the optical circulator 30A. Light transmitted from the optical path 1A is divided into S-polarized light and P-polarized light by a polarization beam splitter SA. The P-polarized light as it is and the S-polarized light after being reflected by the single-sided mirror CMA pass through a ½ wavelength plate and a Faraday rotator in this order, are multiplexed by the polarization beam splitter SB, and travel to the optical path 3. Note that, when the P-polarized light and the S-changed light pass through the ½ wavelength plate and the Faraday rotator in this order, the polarization state does not change.

Further, light coming from the optical path 3 is divided into S-polarized light and P-polarized light by the polarization beam splitter SB. The S-polarized light and the P-polarized light split by the polarization beam splitter SB pass through the Faraday rotator and the ½ wavelength plate in this order to thereby be in a polarization state rotated by 90 degrees, and after being multiplexed by the polarization beam splitter SA, the S-polarized light and the P-polarized light are reflected by the single-sided mirror CMB, the single-sided mirror CMC, and the double-sided mirror CMB, and travel to the optical path 1C. The optical circulator 30B in FIG. 1 has a bilaterally symmetrical structure with the optical circulator 30A.

A method for inserting double-sided mirror MA into the trench 13 will be described with reference to FIGS. 5 to 8. FIG. 5(a) illustrates an example of a state before the double-sided mirror MA is inserted into the trench 13. As illustrated in FIG. 5(a), the PLC 11 is provided with the trench 13 perpendicular to the optical path 3 as described above. The PLC 11 includes an opposing lens 17-1 and an opposing lens 17-2 that are exposed to the trench 13 and oppose each other. In addition, one end of the optical waveguide 12-1 is connected to an optical fiber FE (not illustrated) constituting the optical path 1, and the other end is connected to the opposing lens 17-1. One end of the optical waveguide 12-2 is connected to an optical fiber FF (not illustrated) constituting the optical path 2, and the other end is connected to the opposing lens 17-2.

FIG. 5(b) illustrates an exemplary structure of the double-sided mirror MA. As illustrated in FIG. 5(b), the double-sided mirror MA is bonded to the prism 16, and a spring or the like 15 having a repulsive force against the pushing of the prism 16 is attached below the prism 16. The spring or the like 15 are connected to the bottom of the trench 13 as illustrated in FIG. 5(a). The positional relationship between double-sided mirror MA and the prism 16 is not limited thereto. For example, the double-sided mirror MA and the prism 16 may be vertically opposite to the positional relationship illustrated in FIG. 5(a), and the double-sided mirror MA and the bottom of the trench 13 may be connected by the spring or the like 15. The optical switch 10 may include a plate 21 having a depression. The plate 21 having the depression functions as a pushing member, and is disposed so that the upper portion of the double-sided mirror MA enters the depression 21D, and is movable in an optical path direction perpendicular to the thickness direction of the PLC 11 from this state. The depression 21D is disposed on the pushing surface 21S of the plate 21 and is oblique to the cladding of the PLC 11. When the pushing surface 21S moves in the optical path direction, a pushing amount of the double-sided mirror into the trench 13 can be controlled. In addition, the length and strength of the spring or the like 15 and the distance between the plate 21 and the PLC 11 are desirably adjusted so that the prism 16 is disposed on the axes of the optical waveguide 12-1 and the optical waveguide 12-2 when the double-sided mirror MA is in the depression. When the double-sided mirror MA is in the depression, light passing through the optical path 3 passes through the optical waveguide 12-1, the opposing lens 17-1, the prism 16, the optical waveguide 12-2, and the opposing lens 17-2. Here, it is assumed that the opposing lens 17-1, the prism 16, and the opposing lens 17-2 are included in the optical path 3.

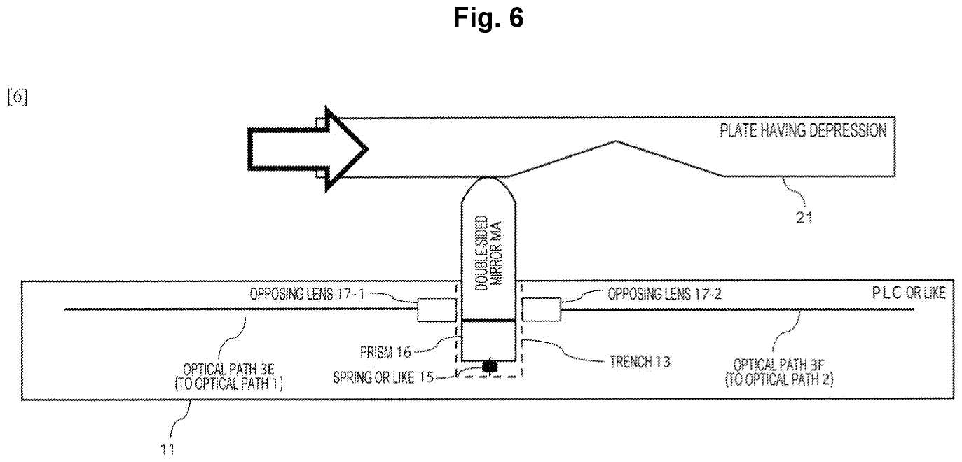

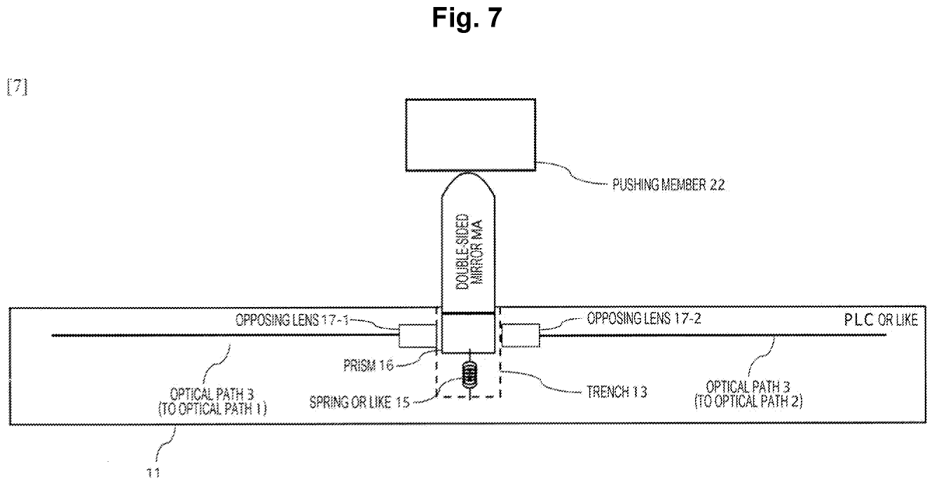

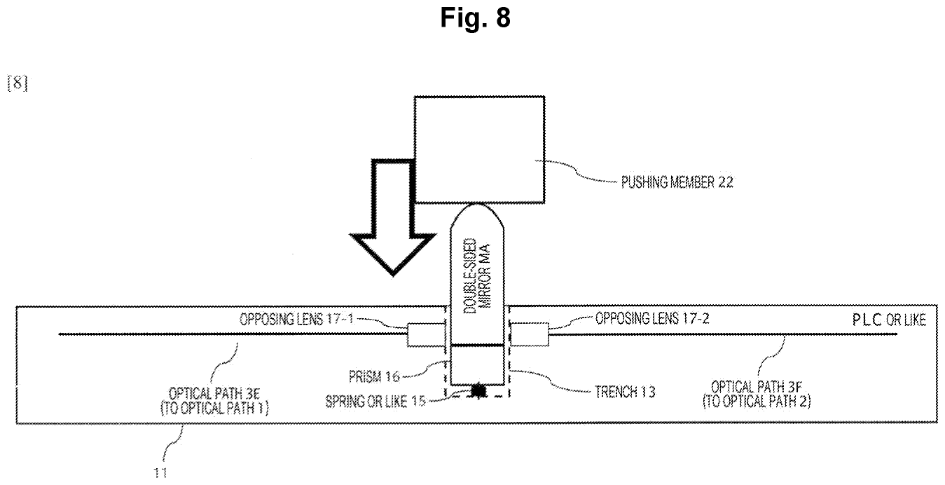

FIG. 6 is a diagram in which the plate 21 having the depression is moved in parallel with respect to the optical path 3 of the PLC 11. The double-sided mirror MA is removed from the depression by the parallel movement of the plate 21 having the depression, and the double-sided mirror MA is inserted into the trench 13 by being pushed into the PLC 11. Thus, the prism 16 on the optical path 3 is changed to the double-sided mirror MA, the light coming from the optical path 1 is totally reflected in the direction of the optical path 1, and the light coming from the direction of the optical path 2 is totally reflected in the direction of the optical path 2. It is similar when a plate having a slope is used instead of the plate 21 having the depression. FIGS. 7 and 8 illustrate a configuration in which the double-sided mirror MA is pushed by a pushing member 22 instead of the plate 21 having the depression. The pushing member 22 may be a member that can intentionally control expansion and contraction by a temperature change or the like, or a mechanism that converts rotation of a motor or the like into piston movement or the like. For the optical path 3 blocked by the prism 16, a portion of the optical path 3 on the optical path 1 side with respect to the double-sided mirror MA is defined as an optical path 3E, and a portion of the optical path 3 on the optical path 2 side with respect to the double-sided mirror MA is defined as an optical path 3F.

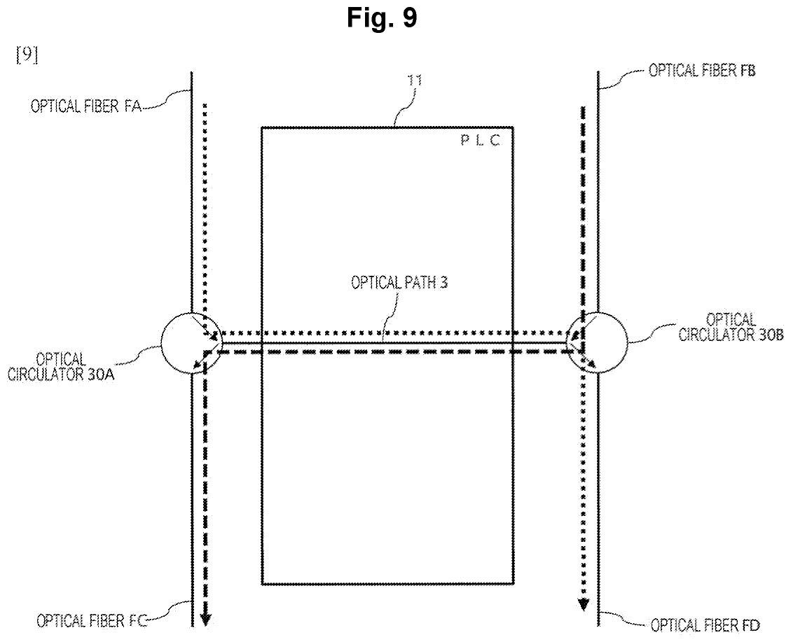

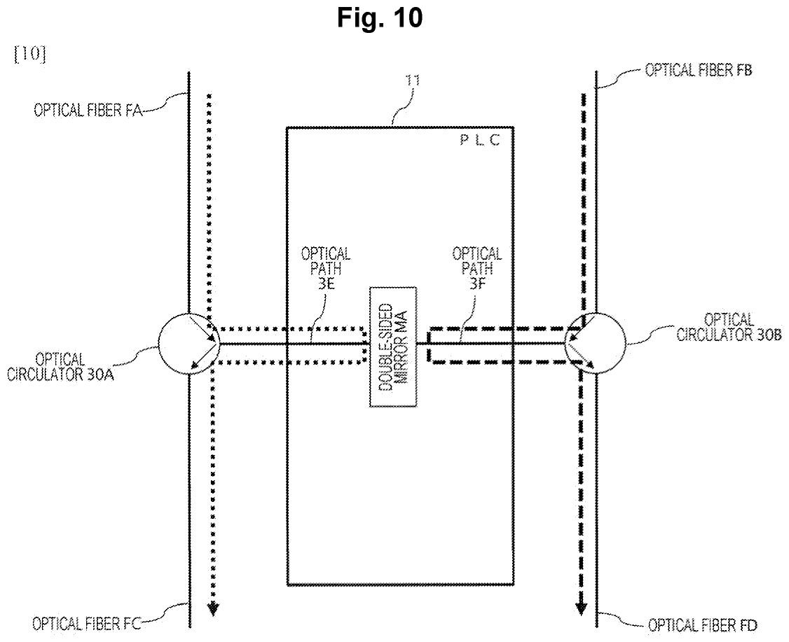

An example of optical path switching using the double-sided mirror MA in the optical switch 10 of FIG. 1 will be described with reference to FIGS. 9 and 10. FIG. 9 illustrates the optical switch 10 in a state where the double-sided mirror MA (not illustrated) is not inserted into the trench 13. In the optical switch 10 according to the present embodiment, as illustrated in FIG. 9, the light incident from the optical fiber FA toward the optical circulator 30A is emitted to the optical path 3 through the optical circulator 30A, and then emitted to the optical fiber FD through the optical circulator 30B. Similarly, the light incident from the optical fiber FB toward the optical circulator 30B is emitted to the optical path 3 through the optical circulator 30B, and then emitted to the optical fiber FC through the optical circulator 30A.

Next, a case where double-sided mirror MA is inserted into the trench 13 will be described with reference to FIG. 10. As illustrated in FIG. 10, when the double-sided mirror MA is inserted into the trench 13, the light incident from the optical fiber FA toward the optical circulator 30A is emitted to the optical path 3E through the optical circulator 30A, is then reflected by the double-sided mirror MA, propagates again through the optical path 3E toward the optical circulator 30A, and is emitted to the optical fiber FC through the optical circulator 30A. Similarly, the light incident from the optical fiber FB toward the optical circulator 30B is also reflected by the double-sided mirror MA and is thereby finally emitted to the optical fiber FD. Therefore, as illustrated in FIGS. 9 and 10, the optical switch 10 according to the present embodiment can change the optical path depending on whether or not the double-sided mirror MA is inserted into the trench 13, and functions as an optical switch.

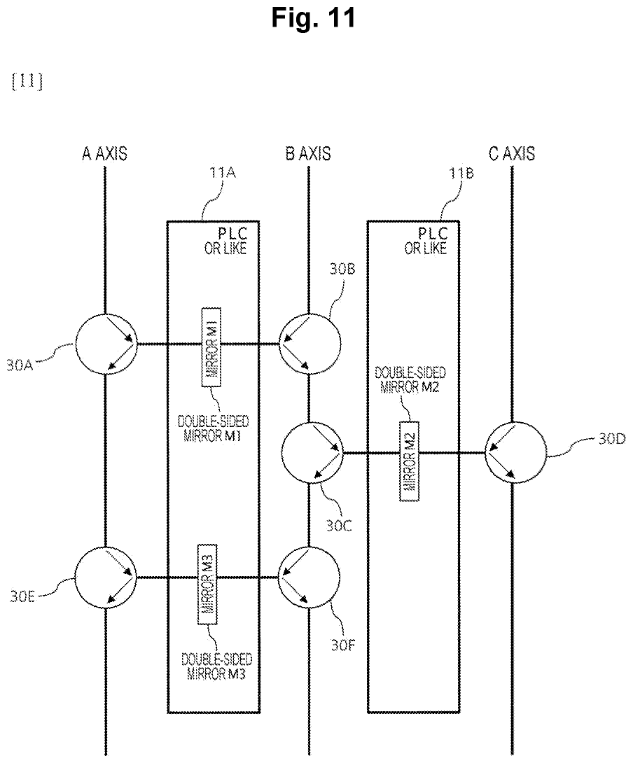

Although the optical switch 10 functioning as two inputs and two outputs has been described above, an optical switch having three inputs and three outputs or more can be achieved by combining the optical switch 10. An example of an optical switch functioning as three inputs and three outputs is illustrated in FIG. 11. In FIG. 11, the optical fiber and the optical circulator are arranged on three axes of the A axis, the B axis, and the C axis. Specifically, three optical fibers and an optical circulator 30A or 30E are disposed between the three optical fibers on the A axis. On the B axis, four optical fibers and an optical circulator 30B, 30C, or 30F are disposed between the optical fibers. On the C axis, two optical fibers and an optical circulator 30D are arranged therebetween. A PLC 11A is disposed between the A axis and the B axis. The PLC 11A has two optical paths 3 described above in parallel, and has a configuration in which a double-sided mirror MA and a double-sided mirror MC of the same structure and operation as those of the double-sided mirror MA described above are arranged for each optical path 3. The PLC 11A connects between the optical circulators 30A and 30B and between the optical circulators 30E and 30F by two optical paths 3. A PLC 11B identical to the PLC 11 described above is disposed between the B axis and the C axis, and the optical circulators 30C and 30D are connected by the optical path 3. The optical switch illustrated in FIG. 11 achieves arbitrary optical path switching by independently controlling the insertion/non-insertion states of the double-sided mirrors MA, B, and C, and functions as a three-input three-output optical switch.

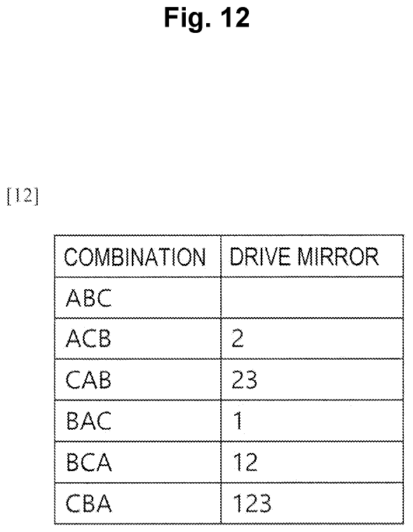

FIG. 12 illustrates a combination of patterns of optical path switching of the three-input three-output optical switch and the numbers of the drive mirrors. The drive mirror means a double-sided mirror in a state of being inserted into a trench. The combination illustrated in FIG. 12 represents an output destination of light input to the A axis, an output destination of light input to the B axis, and an output destination of light input to the C axis from the left. For example, the first line of FIG. 12 is a case where none of the double-sided mirror M1 represented by the number 1 in FIG. 12, the double-sided mirror M2 represented by the number 2 in FIG. 12, and the double-sided mirror M3 represented by the number 3 in FIG. 12 is driven, and in this case it means that the light input to the A axis is output to the A axis, the light input to the B axis is output to the B axis, and the light input to the C axis is output to the C axis. Since the combination of the patterns of optical path switching in the three-input three-output optical switch has three inputs and three outputs, the combination of the patterns of optical path switching can be calculated by the factorial of three, and there are six combinations.

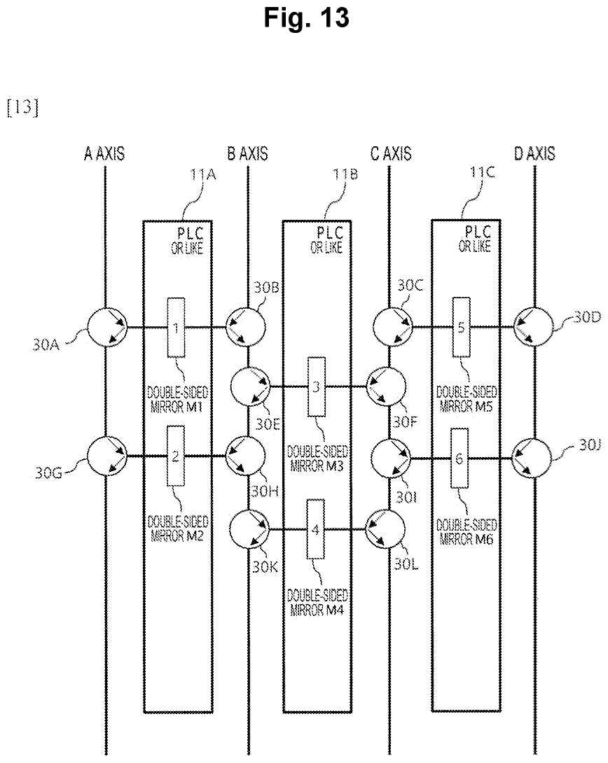

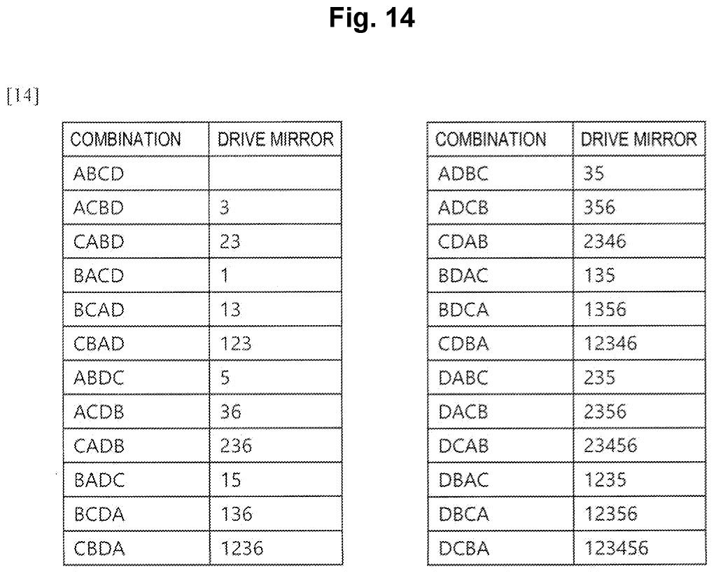

An example of the four-input four-output optical switch is illustrated in FIG. 13. Similarly to the three-input three-output optical switch illustrated in FIG. 11, a four-input four-output optical switch can be achieved by combining a plurality of optical fibers, an optical circulator, and a PLC. Further, FIG. 14 illustrates a combination of patterns of optical path switching of the four-input four-output optical switch and the number of the drive mirror. Since the number of inputs and outputs of the four-input four-output optical switch is four, the number of combinations of patterns of optical path switching can be calculated by the factorial of four, which is 24.

As described above, the optical switch is configured to execute optical path switching in which light incident from the upper fiber group is emitted to any lower fiber group.

### Second Embodiment

The optical switch 10 according to the first embodiment emits light incident from either the optical fiber FA or the optical fiber FB, which is an upper fiber group, to either the optical fiber FC or the optical fiber

FD, which is a lower fiber group, and is an optical switch that can be applied only to an optical signal in one direction from the upper fiber group toward the lower fiber group.

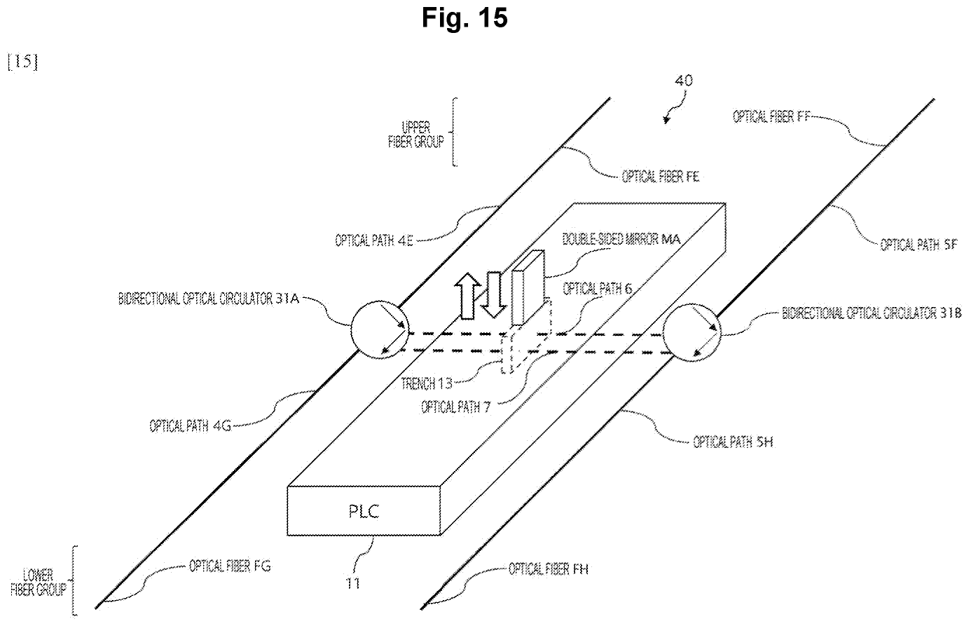

An optical switch 40 according to the present embodiment is illustrated in FIG. 15. The optical switch 40 according to the present embodiment is a bidirectional optical switch capable of switching optical paths of light from an upper fiber group of the optical fiber FE and the optical fiber FF and light from a lower fiber group of the optical fiber FG and the optical fiber FH.

In the present embodiment, as illustrated in FIG. 15, the optical fiber FE and the optical fiber FG are connected by an optical circulator 31A, and the optical fiber FF and the optical fiber FH are connected by an optical circulator 31B. In addition, the optical fiber FE is referred to as an optical path 4E, the optical fiber FG is referred to as an optical path 4G, and the optical path 4E and the optical path 4G are collectively referred to as an optical path 4. Similarly, the optical fiber FF is referred to as an optical path 5F, the optical fiber FH is referred to as an optical path 5H, and the optical path 5F and the optical path 5H are collectively referred to as an optical path 5.

Two optical paths, an optical path 6 and an optical path 7, are arranged between the optical circulator 31A and the optical circulator 31B. Each of the optical path 6 and the optical path 7 has a configuration similar to that of the optical path 3 in the first embodiment and is parallel to each other. However, the trench 13 on both the optical paths of the optical path 6 and the optical path 7 is shared, and the optical path 6 and the optical path 7 can be simultaneously blocked by inserting a shared double-sided mirror MA into the trench 13. In addition, a prism constituting the optical path 6 and the optical path 7 is also shared. Note that the structure and operation of the double-sided mirror MA are similar to those of the first embodiment.

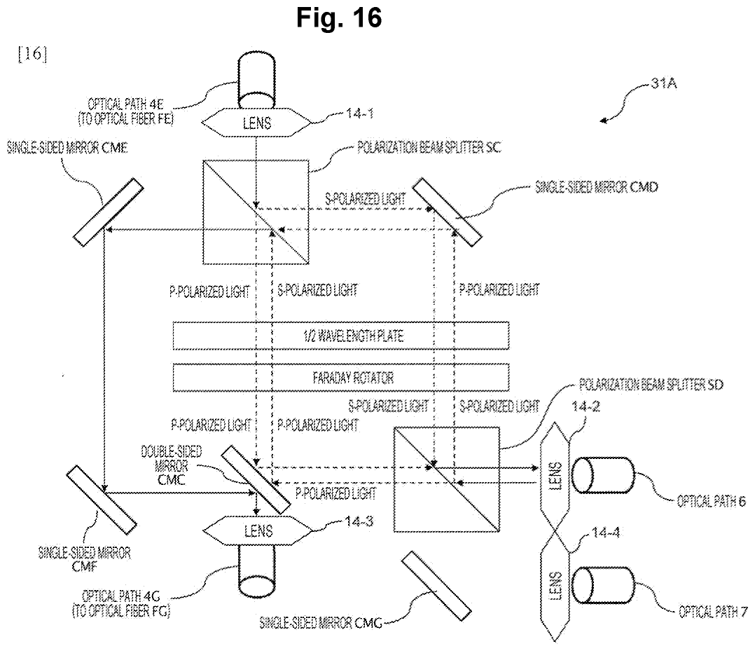

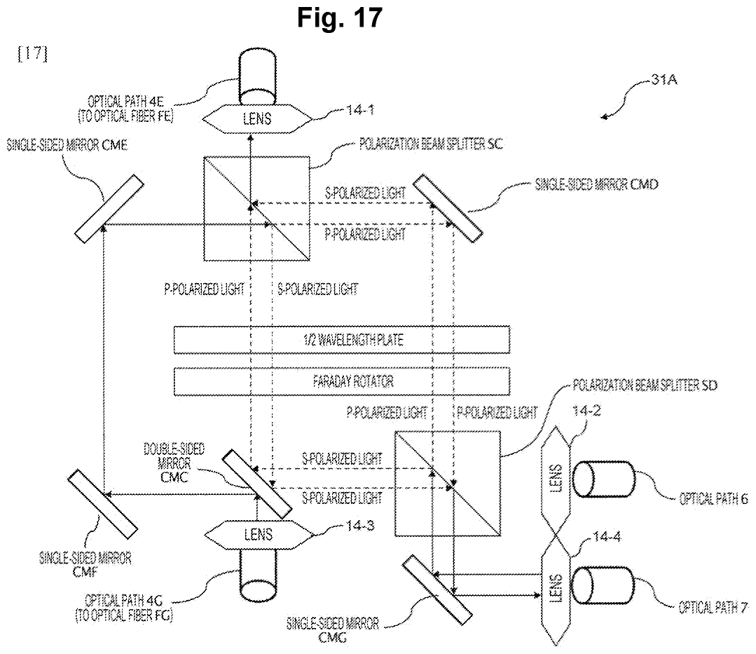

An example of the configuration and operation of the bidirectional optical circulator 31A is illustrated in FIGS. 16 and 17. Compared with the optical circulator 30A illustrated in FIG. 4, the bidirectional optical circulator 31A further includes a lens 14-4 serving as an interface with the optical path 7 and a single-sided mirror CMG that reflects light to the lens 14-4 or reflects light from the lens 14-4.

In FIG. 16, the optical path 4E, the optical path 4G, and the optical path 6 correspond to the optical path 1A, the optical path 1C, and the optical path 3 in the first embodiment, respectively. Then, the bidirectional optical circulator 31A illustrated in FIG. 16 performs an operation similar to that of the optical circulator 30A illustrated in FIG. 4. That is, FIG. 16 illustrates an operation of the optical fiber 40 at the time of optical path switching of light traveling from the upper fiber group to the lower fiber group. The light incident from the optical fiber FE, which is the upper fiber group, enters the bidirectional optical circulator 31A from the optical path 4E, travels similarly to the optical circulator 30A in FIG. 4, and travels to the optical path 6. Further, the light incident from the optical path 6 also travels to the optical path 4G on the lower fiber group side as in the optical circulator 30A of FIG. 4.

On the other hand, FIG. 17 illustrates the operation of the bidirectional optical circulator 31A at the time of optical path switching of light traveling from the lower fiber group toward the upper fiber group, which is an operation that the optical circulator 30A of the first embodiment does not have. In FIG. 17, light incident from the optical fiber FG, which is a lower fiber group, enters the bidirectional optical circulator 31A from the optical path 4G, is reflected by the single-sided mirror CMF, the single-sided mirror CME, and the double-sided mirror CMC in this order, and then is split into P-polarized light and S-polarized light by the polarization beam splitter SC. Thereafter, the S-polarized light as it is and the P-polarized light after being reflected by the single-side mirror CMD pass through the ½ wavelength plate and the Faraday rotator, are multiplexed by the polarization beam splitter SD, are then reflected by the single-sided mirror CMG and travel to the optical path 7. Note that, when the P-polarized light and the S-changed light pass through the ½ wavelength plate and the Faraday rotator in this order, the polarization state does not change.

In addition, the light incident on the bidirectional optical circulator 31A from the optical path 7 is reflected by the single-sided mirror CMG and then demultiplexed into P-polarized light and S-polarized light by the polarization beam splitter SD. Then, the P-polarized light as it is and the S-polarized light after being reflected by the single-sided mirror CMC pass through the Faraday rotator and the ½ wavelength plate in this order to thereby be in a polarization state rotated by 90 degrees, and are multiplexed by the polarization beam splitter SC and emitted to the optical path 4E toward the upper fiber group.

As described above, the bidirectional optical circulator 31A is characterized by emitting light to the optical path 6 when the light incident from the optical path 4E of the upper fiber group, emitting light to the optical path 4G of the lower fiber group when the light incident from the optical path 6, emitting light to the optical path 7 when the light incident from the optical path 4G of the lower fiber group, and emitting light to the optical path 4E of the upper fiber group when the light incident from the optical path 7. The bidirectional optical circulator 31B in FIG. 15 has a structure that is left-right reversed to that of the bidirectional optical circulator 31A.

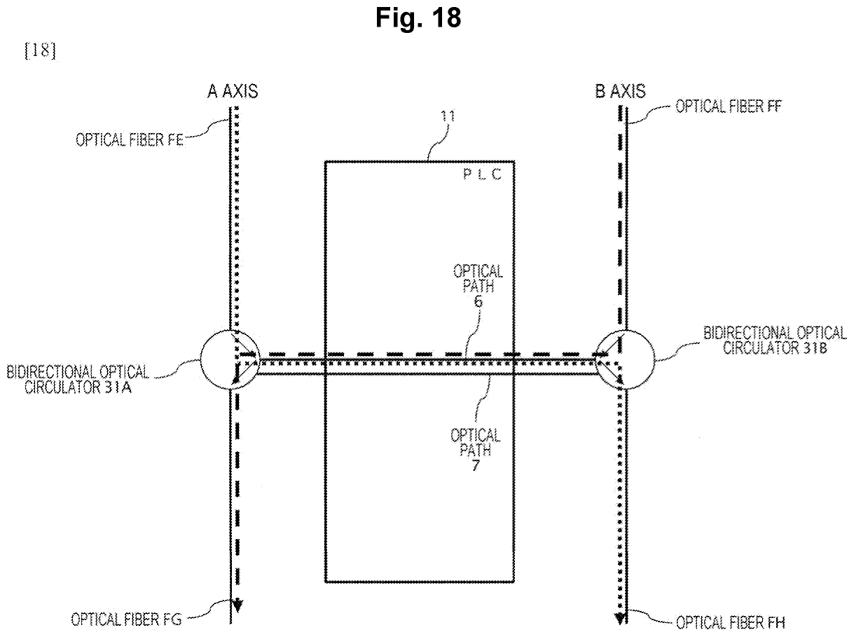

An example of optical path switching using the double-sided mirror MA in the optical switch 40 of FIG. 15 will be described with reference to FIGS. 18 to 21. FIG. 18 illustrates a propagation path of light in a case where the light is incident from the upper fiber group in a state where the double-sided mirror MA (not illustrated) is not inserted into the trench 13. Light incident from the optical fiber FE toward the optical circulator 31A is emitted to the optical path 6 through the optical circulator 31A, and then emitted to the optical fiber FH through the optical circulator 31B. Similarly, light incident from the optical fiber FF toward the optical circulator 31B is emitted to the optical path 6 through the optical circulator 31B, and then emitted to the optical fiber FG through the optical circulator 31A.

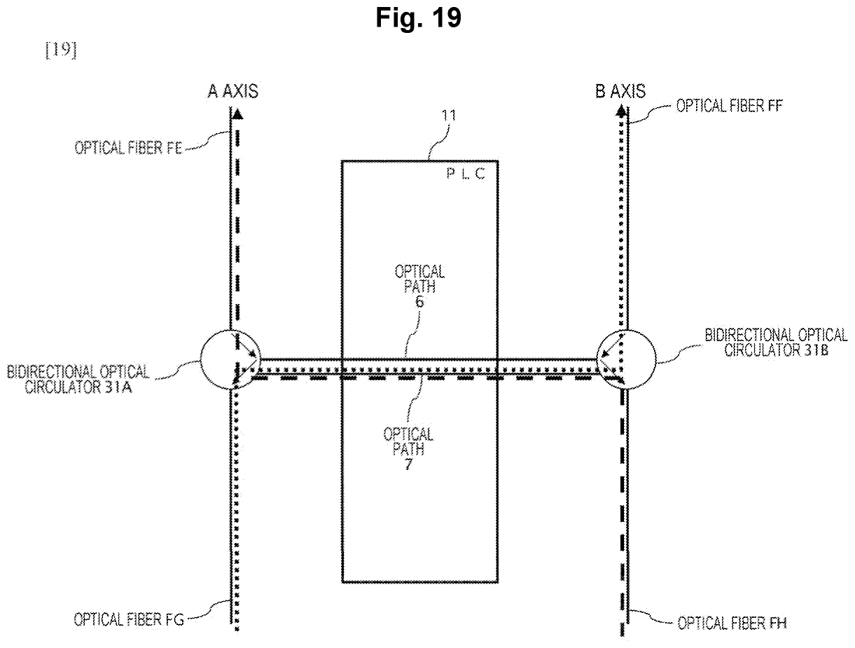

FIG. 19 illustrates a propagation path of light in a case where the light is incident from the lower fiber group in a state where the double-sided mirror MA (not illustrated) is not inserted into the trench 13. Light incident from the optical fiber FG toward the optical circulator 31A is emitted to the optical path 7 through the optical circulator 31A, and then emitted to the optical fiber FF through the optical circulator 31B. Similarly, light incident from the optical fiber FH toward the optical circulator 31B is emitted to the optical path 7 through the optical circulator 31B, and then emitted to the optical fiber FE through the optical circulator 31A. As described above, in the bidirectional optical switch 40, regardless of whether the traveling direction of light is from the upper fiber group to the lower fiber group or from the lower fiber group to the upper fiber group, the same optical connection state, that is, a state in which incident light passes through the PLC 11 and is output from an axis different from the incident axis is formed.

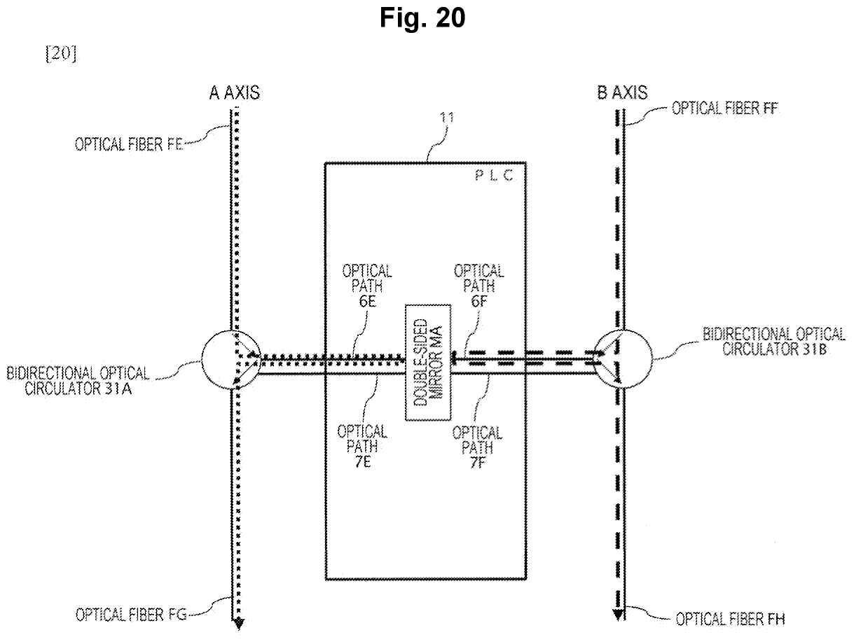

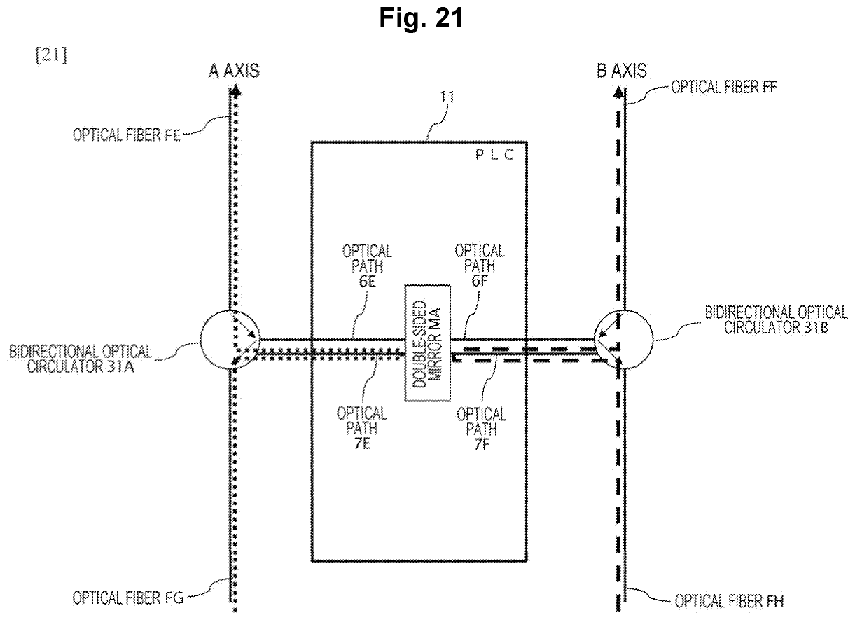

FIG. 20 illustrates a propagation path of light in a case where the light is incident from the upper fiber group in a state where the double-sided mirror MA is inserted into the bidirectional optical switch 40. In FIG. 20 and FIG. 21 described later, regarding the optical path 6 blocked by the double-sided mirror MA, a portion between the double-sided mirror MA and the optical circulator 31A is defined as an optical path 6E, and a portion between the double-sided mirror MA and the optical circulator 31B is defined as an optical path 6F in the optical path 6. Similarly, it is assumed that the optical path 7 is divided into an optical path 7E and an optical path 7F by the double-sided mirror MA.

As illustrated in FIG. 20, when the double-sided mirror MA is inserted into the trench 13, the light incident from the optical fiber FE toward the optical circulator 31A is emitted to the optical path 6E through the optical circulator 31A, is then reflected by the double-sided mirror MA, again propagates through the optical path 6E toward the optical circulator 31A, and is emitted to the optical fiber FG through the optical circulator 31A. Similarly, the light incident from the optical fiber FF toward the optical circulator 31B is also reflected by the double-sided mirror MA and is thereby finally emitted to the optical fiber FH.

FIG. 21 illustrates a propagation path of light in a case where the light is incident from the lower fiber group in a state where the double-sided mirror MA is inserted into the bidirectional optical switch 40. As illustrated in FIG. 21, when the double-sided mirror MA is inserted into the trench 13, the light incident from the optical fiber FG toward the optical circulator 31A is emitted to the optical path 7E through the optical circulator 31A, is then reflected by the double-sided mirror MA, again propagates through the optical path 7E toward the optical circulator 31A, and is emitted to the optical fiber FE through the optical circulator 31A. Similarly, the light incident from the optical fiber FH toward the optical circulator 31B is also reflected by the double-sided mirror MA and is thereby finally emitted to the optical fiber FF. As described above, in the bidirectional optical switch 40, regardless of whether the traveling direction of light is from the upper fiber group to the lower fiber group or from the lower fiber group to the upper fiber group, the same optical connection state, that is, a state in which incident light is reflected by the PLC 11 and is output from the same axis as the incident axis is formed.

As described above, unlike the first embodiment, the optical switch 40 according to the present embodiment is an optical switch having an optical path switching function that can be used even in a case of bidirectional optical communication. In addition, the bidirectional optical switch can also be configured as an N-input and N-output switch having three inputs and three outputs or more, similarly to FIGS. 11 and 13 in the first embodiment.

### Third Embodiment

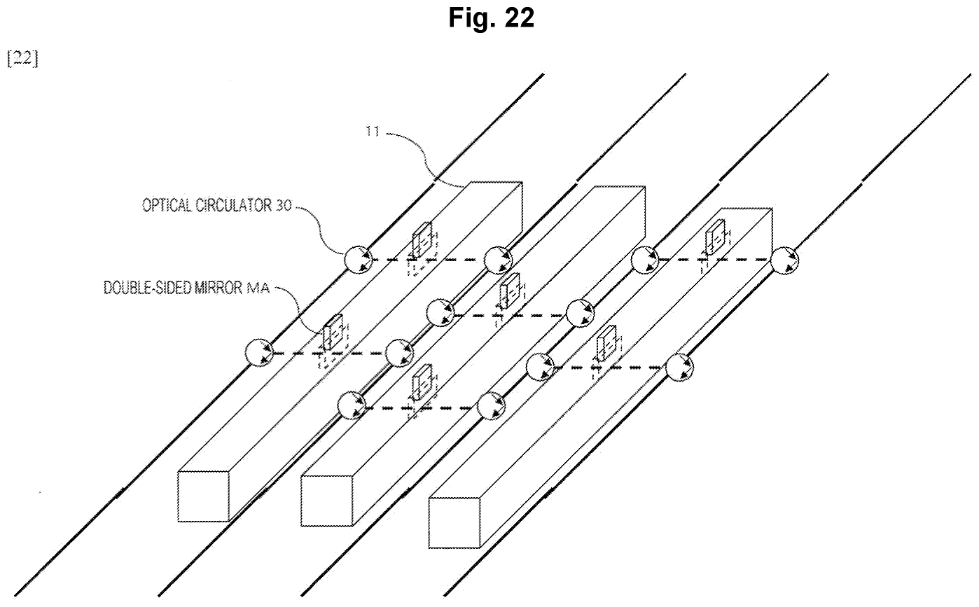

In the first embodiment and the second embodiment, connection accompanied by optical path switching between the upper fiber group and the lower fiber group is achieved by a combination of insertion states of the plurality of double-sided mirrors MA on the optical path. A four-input four-output optical switch is illustrated in FIG. 22. Although the optical circulator 30 is illustrated in FIG. 22, the bidirectional circulator 31 may be used. When there is a plurality of double-sided mirrors in the optical switch system as illustrated in FIG. 22, the plurality of double-sided mirrors MA may be simultaneously controlled.

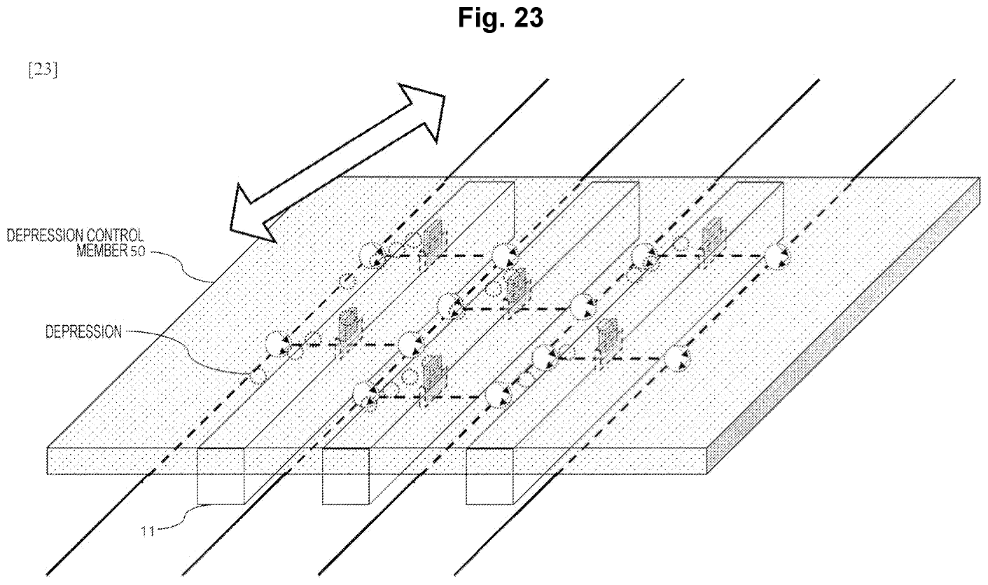

Specifically, the optical switch system may include a depression control member 50 having a depression corresponding to the position of each double-sided mirror MA. As illustrated in FIG. 23, the insertion/non-insertion state of all double-sided mirrors MA may be controlled at the same time by moving the depression control member in which the depression is carved at the position corresponding to each double-sided mirror MA. Thus, the optical path switching can be achieved with a smaller number of parts than in a case where the driving of the double-sided mirror MA is controlled by each double-sided mirror MA.

### Fourth Embodiment

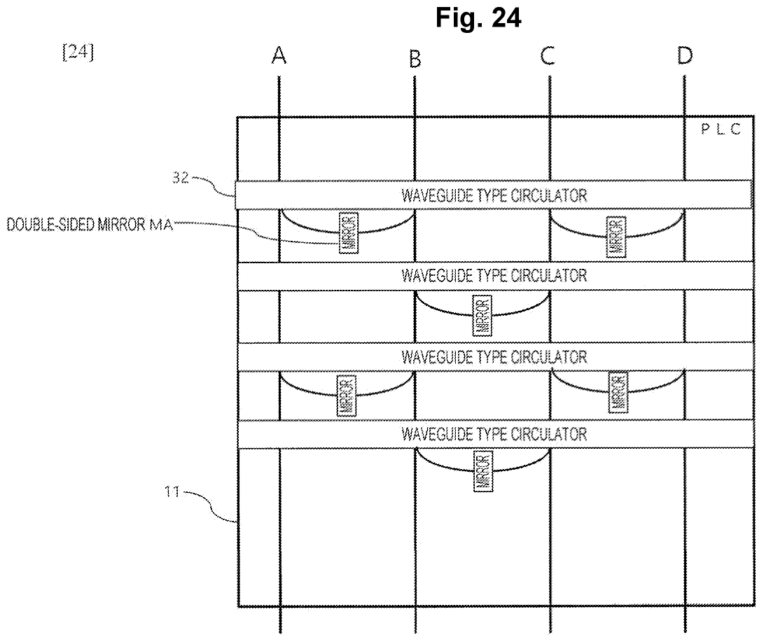

The optical circulator 30 according to the first embodiment and the bidirectional optical circulator 31 according to the second embodiment may be formed into an array and integrated by the waveguide type circulator 32 (see, for example, Patent Literatures 1 to 3) as illustrated in FIG. 24, thereby simplifying manufacturing and manufacturing at a low cost.

### (Advantageous Effects of Invention)

Since an optical path is switched only by driving a small and lightweight double-sided mirror, the optical switch operates with smaller energy than before. In addition, when an N×N switch is constructed by combining a plurality of 1×N switches, it is necessary to connect the 1×N switches to each other in a full mesh shape, and fusion connection of the square of N or the like occurs, which causes a problem of an increase in size of the switch. However, this switch can be manufactured in a small size.

### (Point of Invention)

By inserting a double-sided mirror into an optical path including a PLC and optical circulators, it is possible to express any connection state between an upper fiber group and a lower fiber group like a ladder lottery formed by optical paths.

### INDUSTRIAL APPLICABILITY

An optical switch and an optical switch system according to the present disclosure can be applied to the information communication industry.

### REFERENCE SIGNS LIST

10, 40 Optical switch
11 PLC
12, 12-1, 12-2 Optical waveguide
13 Trench
14 Lens
15 Spring or the like
16 Prism
17-1, 17-2 Opposing lens
21 Plate having depression
21D Depression
21S Pushing surface
22 Pushing member
30 Optical circulator
31 Bidirectional optical circulator
32 Waveguide type circulator

1. An optical switch, comprising:
a plate-shaped cladding provided with a trench in a thickness direction;
opposing lenses exposed to the trench;
two optical waveguides coaxially arranged inside the cladding, respective one ends of the optical waveguides being exposed to a surface of the cladding and respective other ends of the optical waveguides opposing each other in the trench via the opposing lenses;
a movable transparent body that transmits light of the opposing lenses when the transparent body is sandwiched by the opposing lenses in the trench; and
a movable double-sided mirror that reflects light incident from the opposing lenses in a direction opposite to an incident direction when the double-sided mirror is sandwiched between the opposing lenses in the trench.

2. The optical switch according to claim 1, further comprising:
a movable portion configured by the transparent body and the double-sided mirror overlapping each other in the thickness direction;
a spring that connects the movable portion and a bottom of the trench; and
a pushing member that has a pushing surface in contact with an upper portion of the double-sided mirror and controls a pushing amount of the double-sided mirror into the trench by movement of the pushing surface.

3. The optical switch according to claim 2, wherein
the pushing surface of the pushing member is oblique to the cladding, and the pushing member controls the pushing amount of the double-sided mirror into the trench by movement of the pushing surface in a direction perpendicular to the thickness direction.

4. The optical switch according to claim 1, further comprising:
second opposing lenses exposed to the trench; and
two second optical waveguides disposed inside the cladding on respective axes parallel to the axes of the two optical waveguides, respective one ends of the optical waveguides being exposed to a surface of the cladding and respective other ends of the optical waveguides opposing each other in the trench via the second opposing lenses, wherein
the transparent body transmits light of the second opposing lenses when the transparent body is sandwiched by the second opposing lenses, and
the double-sided mirror reflects light incident from the second opposing lenses in a direction opposite to an incident direction when the double-sided mirror is sandwiched by the second opposing lenses.

5. An optical switch system, comprising:
the optical switch according to claim 1;
two three-port optical circulators that output an input of light from a first port to a second port and output an input of light from the second port to a third port;
two upper optical fibers connected to the first ports of the two three-port optical circulators;
two connecting optical fibers that connect the second ports of the two three-port optical circulators and the one ends of the two optical waveguides; and
two lower optical fibers connected to the third ports of the two three-port optical circulators, wherein
light incident from any one of the upper optical fibers is emitted to any one of the lower optical fibers to function as a two-input two-output optical switch.

6. An optical switch system, comprising:
the optical switch according to claim 4;
two four-port optical circulators that output an input of light from a first port to a second port, output an input of light from the second port to a third port, output an input of light from the third port to a fourth port, and output an input of light from the fourth port to the first port;
two upper optical fibers connected to the first ports of the two four-port optical circulators;
two first connecting optical fibers that connect the second ports of the two four-port optical circulators and the one ends of the two optical waveguides;
two lower optical fibers connected to the third ports of the two four-port optical circulators; and
two second connecting optical fibers that connect the fourth ports of the two four-port optical circulators and the one ends of the two second optical waveguides, wherein light incident from any one of the upper optical fibers is emitted to any one of the lower optical fibers, and light incident from any one of the lower optical fibers is emitted to any one of the upper optical fibers to function as a two-input two-output optical switch.

7. An optical switch system, wherein
the optical switch system is combined with the optical switch system according to claim 5 to function as an N-input and N-output optical switch.

8. The optical switch system according to claim 5, wherein
the three-port optical circulator or the four-port optical circulator is a waveguide type circulator.
